(19) United States
(12) Patent Application Publication
(10) Pub. No.: US 2010/0146431 A1
(43) Pub. Date: Jun. 10, 2010

(54) OBJECT PICKER WITH WINDOW SPLITTER

(75) Inventors: Vijaye G. Raji, Redmond, WA (US); Christopher Lee Anderson, Redmond, W (US); Bradford H. Lovering, Clyde Hill, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/331,240

(22) Filed: Dec. 9, 2008

(51) Int. Cl. G06F 3/048

(52) U.S. Cl. 715/781

(57) ABSTRACT

An application work area that includes a splitting mechanism that permits the work area to be divided into multiple windows. Each window is capable of displaying a selected object of the available objects that are open in the application. Each window might include a corresponding distinct object selection mechanism that allows a user to select one of the open objects to display in the corresponding window. In one embodiment, this is permitted regardless of whether that open object is already displayed in another of the windows. As examples, the object selection mechanism may be a selectively viewable open object list such as, for example, a drop down list. Thus, each window that has an object selection mechanism may be used to independently control the object that is viewed in that window.

### BACKGROUND

Often, the most effective way to convey information to a human being is visually. Accordingly, computing systems that interface with a user almost inevitably have a display that which a user might interface with various applications.

Some applications have Single Document Interfaces (SDI) that allow the user to open and work with only one object at a time. A quintessential example of an object that a user might work with is a document. With SDI interfaces, when the user wants to work on a different document, the user would have to close the currently open document and open the document that the user would like to now work on. Alternatively, the user might create a new instance of the same application for each document to be displayed. An example of an application with an SDI interface is MICROSOFT® Notepad.

Multiple Document Interfaces (MDI) allow the user to open and work with multiple documents at the same time. When the user wants to switch from one open document to another document, the user could use some switching mechanism (such as a drop down menu) to pick another open document. Another example of such a switching mechanism is the keyboard shortcut Ctrl+Tab. In response to the switching, the target open document becomes active and the user can work in this document, without having to close the old document. The user could always come back to the old document and continue work from where the user left off since the old document remains open. Examples of applications with an MDI interface are MICROSOFT® EXCELR and MICROSOFT® Word.

One issue with the SDI and MDI models is that with the larger displays that are available more recently, maximizing just one document to the entire screen results in wasted space. The MDI interface often provides additional commands like “tile” and “cascade”, but they lack some types of fine-tuned control to the user about which documents to make visible and which ones to hide. For instance, if one were to use to “tile” control when having many documents open, only a small window would be devoted to each open document. The window may be so small that it is difficult to work with that document in that context of that window.

At least one application, MICROSOFT® VISUAL STUDIO®, has provided a reasonable solution to this issue with the use of splits and tabs. Splits allow the work area to be split into separate windows so long as the split conforms to a set of splitting rules. As an example of a splitting rule, there might be restrictions on about which orientations the splits can be made. For instance, if a vertical split is made, perhaps it is no longer possible to make a horizontal split. Some applications might have more rigid splitting rules, while other applications might be quite liberal on the types of splits permitted. In MICROSOFT® VISUAL STUDIO®, after the display area is split into multiple windows, each window has a tab associated with each open document that is accessible to that window. However, less than all of the complete set of open documents might be available to each window. Nevertheless, the use of splits and tabs gives the user control some control on where to create splits and to some extent what to display inside the splits.

### BRIEF SUMMARY

Embodiments described herein relate to the efficient display of an application work area on a display. The application work area includes a splitting mechanism that permits the work area to be divided into multiple windows. Each window is capable of displaying a selected object of the available objects that are open in the application. Each window might include a corresponding distinct object selection mechanism that allows a user to select one of the open objects to display in the corresponding window. In one embodiment, this is permitted regardless of whether that open object is already displayed in another of the windows. As examples, the object selection mechanism may be a selectively viewable open object list such as, for example, a drop down list. Thus, each window that has an object selection mechanism may be used to independently control the object that is viewed in that window.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a computing system that represents an environment in which the principles described herein may be implemented;

FIG. 2 illustrates an architecture in which an application work area is provided with an splitter for splitting a work area into multiple regions, and a object selection mechanism for picking objects to work on in each window;

FIG. 3A illustrates an example application work area that is split vertically;

FIG. 3B illustrates an example application work area that is split horizontally;

FIG. 3C illustrates an example application work area that is split horizontally and vertically;

FIG. 3D illustrates an example application work area that is split horizontally and vertically and in which the horizontal split line is not aligned;

FIG. 3E illustrates an example application work area that is split horizontally and vertically and in which the vertical split line is not aligned;

FIG. 3F illustrates an example application work area that is split horizontally and vertically and in which not all horizontal and vertical split lines are aligned;

FIG. 4 illustrates a user interface showing an example work area split into multiple windows;

FIG. 5 illustrates a user interface showing an example object selection mechanism that might be associated with one or more of the windows of FIG. 4.

### DETAILED DESCRIPTION

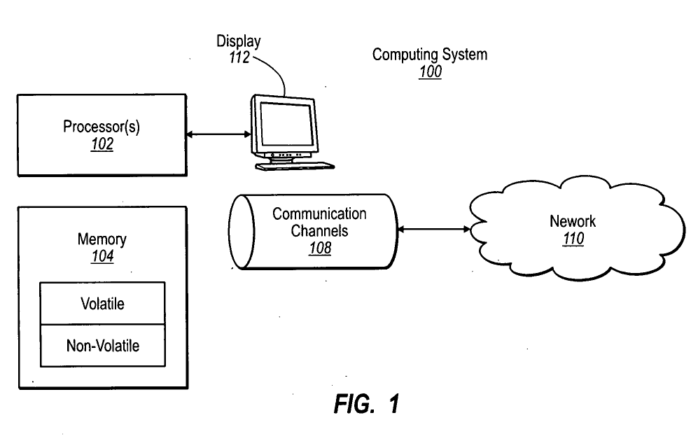

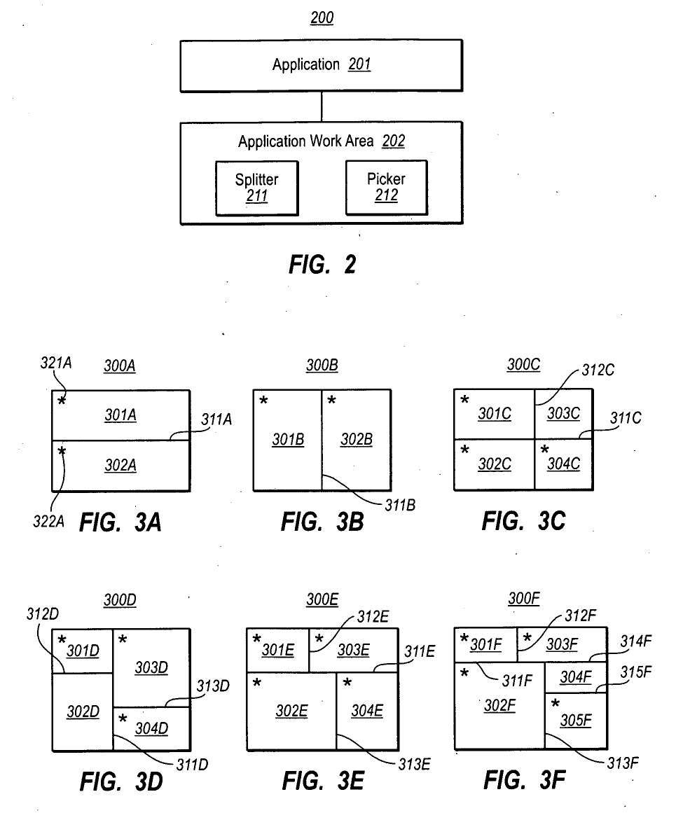

Embodiments described herein relate to an application work area that includes a splitting mechanism that permits the work area to be divided into multiple windows. Each window might include a corresponding distinct object selection mechanism that allows a user to select an open object to display in the corresponding window. In one embodiment, this is permitted regardless of whether that open object is already displayed in another of the windows. As examples, the object selection mechanism may be a selectively viewable open object list such as, for example, a drop down list. Thus, each window that has an object selection mechanism may be used to independently control the object that is viewed in that window. First, some introductory discussion regarding a computing system in which the principles described herein may be employed will be described with respect to FIG. 1. Then, various embodiments of the use of splitters and object pickers will be described with respect to FIGS. 2 through 5.

FIG. 1 illustrates a computing system, which may implement a message processor in software. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system TOO.

Computing system 100 may also contain communication channels 108 that allow the computing system 100 to communicate with other message processors over, for example, network 110. A display 112 may also be provided for displaying an application work interface to the user. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

FIG. 2 illustrates an application 201 that displays an application work area 202. The application 201 really could be any type of application. For instance, the application 201 might be a text editor, in which case, the application work area 202 is used to edit text files. The application 201 might be a spreadsheet application, in which case the application work area 202 might be used to edit spreadsheets. The application 201 might be a word processing application, in which case the application work area 202 might be used to edit word processing documents. There really are no limits as what the function of the application work area 202 might be. The application 201 and the application work area 202 may be formulated using software in one embodiment. In that case, a physical computer program product may have one or more physical computer-readable media having thereon one or more computer-executable instructions that, when executed by one or more processors (e.g., processor(s)102 of the computing system), causes the computing system to operate the application 201.

The application work area 202 includes a splitting mechanism 211 and an object picker mechanism 212. The splitting mechanism 211 is for splitting the application work area into multiple windows. Each window is capable of displaying a selected open object of the available objects that are open in the application. Once again, the type of object for an application will depend on the nature of the application itself For instance if the application is a text editor, the open objects might be text files. If the application is a spreadsheet application, the open objects might be spreadsheet files. If the application is a word processing application, the open objects might be word processing documents. Although these three examples of application have been provided herein, there is no limit to the types of applications that might benefit from the principles described herein. In an application that is capable of displaying multiple types of objects, the objects may be any of those possible types.

As previously mentioned, the splitter 211 allows the application work area to be split into multiple windows. FIGS. 3A through 3F are provided as non-exhaustive examples intended to show the wide variety of ways that an application work area may be split using the principles described herein. These are examples only, as there is literally no restriction on the number or orientation of the windows. Each window may be properly sized to accommodate the best view on the underlying object.

FIG. 3A illustrates an application work area 300A that is split vertically into windows 301A and 302A using horizontal splitting boundary 311A. The asterisks 321A and 322A are illustrated as being associated with respective windows 301A and 302A to symbolically represent a corresponding distinct object selection mechanism that allows a user to select one of the open objects to display in the corresponding window. The asterisks in the remaining FIGS. 3B through 3F also represent such a distinct object selection mechanism with respect to their corresponding windows.

FIG. 3B illustrates an application work area 300B that is split horizontally into windows 301B and 302B using vertical splitting boundary 311B. This demonstrates that splitting boundaries may be horizontal or vertical.

FIG. 3C illustrates an application work area 300C that is split horizontally and vertically into windows 301C, 302C, 303C and 304C using horizontal splitting boundary 311C and vertical splitting boundary 312C. This demonstrates that there may be any number of horizontal and/or vertical splitting boundaries in a single application work area. Furthermore, there may be any number of windows, and may often even be three or more.

FIG. 3D illustrates an application work area 300D that is split horizontally and vertically into windows 301D, 302D, 303D and 304D using splitting boundaries 311D, 312D and 313D. Note how in this case, that the horizontal splitting boundary 312D for the left set of windows 301D and 302D is not be aligned with the horizontal splitting boundary 313D for a right set of windows 303D and 304D.

FIG. 3E illustrates an application work area 300E that is split horizontally and vertically into windows 301E, 302E, 303E and 304E using splitting boundaries 311E, 312E and 313E. Note how in this case, that the vertical splitting boundary 312E for the upper set of windows 301E and 303E is not be aligned with the vertical splitting boundary 313E for a lower set of windows 302E and 304E.

FIG. 3F illustrates an application work area 300F that is split horizontally and vertically into windows 301F, 302F, 303F, 304F and 305F using splitting boundaries 311F, 312F, 313F, 314F and 315F. Of course, splitters 311F and 314F might be considered to be the same splitting boundary, depending on whether the user can move splitting boundaries 311F and 314F independently of each other. In the case of FIG. 3F, that the horizontal and vertical splitting boundary do not always align. Furthermore, there may be different numbers of vertical or horizontal splitting boundaries depending on the position in the application work area. For instance, there is but one horizontal splitting boundary 311F towards the left of the application work area, but two horizontal splitting boundaries 314F and 315F towards the right of the application work area. In one embodiment, the window 304F may instead be unused area not corresponding to a window at all, representing that not all of the application work area need be occupied by a window.

As previously mentioned, at least some of the windows created using the splitting mechanism have a corresponding distinct object selection mechanism that allows a user to select one of the open objects to display in the corresponding window. Thus, for example, in FIG. 3, object selection mechanism 321A may be used to select an open object for display in window 301A, while object selection mechanism 322A may be used to select an open object for display in window 302A. In the case of FIG. 3A, and in probably the preferred case, all of the windows created using the splitting mechanism include a corresponding object selection mechanism. However, the principles described herein are not limited to that. In the case illustrated in FIGS. 3C, 3D, and 3F, there is at least one window that does not have a corresponding object selection mechanism. For instance windows 303C, 302D and 304F are not illustrated as having a corresponding object selection mechanism. In one embodiment, there may be a type of window or another situation when a window is opened in which the object selection mechanism will not be needed.

In one embodiment, the object selection mechanism for any given window allows any of the open objects to be displayed in the corresponding window regardless of whether that open object is already displayed in another of the plurality of windows. Thus, there might be multiple windows representing multiple views on the same open object. The object selection mechanism for each window may permit more operations that just choosing an open object to view. The object selection mechanism might also permit the user to 1) close the open object displayed in the corresponding window, 2) switch a displayed object from one open object to another open object, and/or 3) open a new object thereby adding to the available open objects.

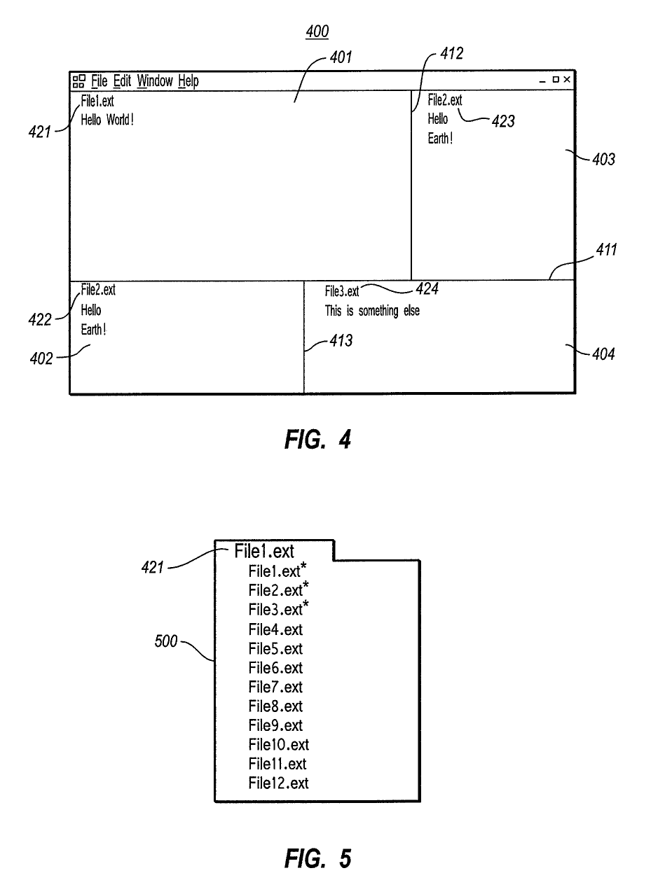

The object selection mechanism in one embodiment is a selectively viewable open object list that may be configured to sometimes show at least some (and potentially all) of the available open objects. In the specific example that will now be shown with respect to FIGS. 4 and 5, the selectively viewable open object list is a drop down list that lists some or all of the open objects upon activation of the drop down list.

FIG. 4 shows a specific example of an application work area 400 that has been divided into four windows 401, 402, 403 and 404 using splitting boundaries 411, 412 and 413. Window 401 shows a view on an open object called File1.ext. In this case, File1.ext is a text file that includes text “Hello World!”. Windows 402 and 403 each show different views on an open object called File2.ext. In this case, File2.ext is a text file that includes the text “Hello Earth!”. If the user were to edit File2.ext, those edits would be applied to the underlying text file, thereby altering the view in the corresponding windows if the changed material is within the view. Window 404 shows a view on an open object called File3.ext. In this case, File3.ext is a text file that includes text “This is something else”.

Each of the windows 401 through 404 includes a corresponding drop down activator 421 through 424 that, when selected, causes a drop down list to appear with all of the open objects listed. For instance, if the user were to select the drop down activator 421, the drop down list 500 of FIG. 5 might appear. In this case, all of the as listed open files from File1.ext through File12.ext are shown. The user might switch the object being viewed in that particular window by simply selecting from that list. The objects that are already being viewed may be marked (e.g., perhaps bolded or italicized) to distinguish from those open files that are not presently being viewed in an open window. Another marker (perhaps an asterisk) might be used to indicate that the file has not been saved since the last modification. In one embodiment, the drop down list might also include a control whereby the user might close an object being viewed, or open a new object.

In there are multiple views on the same object being displayed in different windows as described above, perhaps there would be a separate entry on the object selection mechanism (e.g., the drop down menu of FIG. 4) for each view. This would allows the user to switch from one view of the object to another view of the object within that window. Alternatively, perhaps some other switching mechanism, such as the ALT-TAB keystroke combination, might cause the view of the object to switch in the window.

The principles described herein allow for efficient use of application work area since there are potentially little restrictions on how windows may be divided. Also, the available objects are represented in a selectively viewable object selection list, rather than by using tabs. Accordingly, significant space need not be occupied by the object selection mechanism while the user is viewing the content of the windows. Instead, the object selection mechanism may be expanded only when switching what is being viewed in one of the windows. Furthermore, since all of the open objects may be viewed from any of the windows, there is great flexibility on allowing a user various views on the same object.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A physical computer program product comprising one or more physical computer-readable media having thereon one or more computer-executable instructions that, when executed by one or more processors of a computing system, causes the computing system to operate an application that displays an application work area that comprises:
a splitting mechanism for splitting the work area into a plurality of windows, each window capable of displaying a selected open object of a plurality of open objects that are open in the application, wherein each of at least some of the plurality of windows further comprises:
a corresponding distinct object selection mechanism that allows a user to select one of the plurality of open objects to display in the corresponding window, wherein the object selection mechanism allows any of the open objects to be displayed in the corresponding window regardless of whether that open object is already displayed in another of the plurality of windows.

2. The physical computer program product in accordance with claim 1, wherein the corresponding distinct object selection mechanism is provided for each of as all of the plurality of windows.

3. The physical computer program product in accordance with claim 1, wherein the application is a text editing application, and at least some of the open objects are text objects.

4. The physical computer program product in accordance with claim 1, wherein the application is a word processing application, and the open objects are word processing documents.

5. The physical computer program product in accordance with claim 1, wherein the application is a spreadsheet application, and the open objects are spreadsheets.

6. The physical computer program product in accordance with claim 1, wherein the corresponding distinct object selection mechanism for each of the at least some of the plurality of windows also allows a user to close the open object displayed in the corresponding window.

7. The physical computer program product in accordance with claim 1, wherein the corresponding distinct object selection mechanism for each of the at least some of the plurality of windows also allows a user to switch a displayed object from one open object of the plurality of open objects to another open object of the plurality of open objects.

8. The physical computer program product in accordance with claim 1, wherein the corresponding distinct object selection mechanism for each of the at least some of the plurality of windows also allows a user to open a new object thereby adding to the plurality of open objects.

9. The physical computer program product in accordance with claim 1, wherein the corresponding distinct object selection mechanism for each of the at least some of the plurality of windows is a drop down list that shows at least some of the plurality of open objects.

10. The physical computer program product in accordance with claim 9, wherein the corresponding distinct object selection mechanism for each of the at least some of the plurality of windows is a drop down list that shows all of the plurality of open objects.

11. The physical computer program product in accordance with claim 1, wherein the splitting mechanism performs for splitting both in the horizontal and vertical directions such that a vertical split for an upper set of windows need not be aligned with a vertical split for a lower set of windows.

12. The physical computer program product in accordance with claim 1, wherein the splitting mechanism performs for splitting both in the horizontal and vertical directions such that a horizontal split for a more left set of windows need not be aligned with a horizontal split for a more right set of windows.

13. The physical computer program product in accordance with claim 1, wherein the plurality of windows includes at least three windows.

14. A computer-implemented method for displaying an application work of an application, the method comprising:
an act of providing a splitting mechanism for splitting the work area into a plurality of windows, each window capable of displaying a selected open object of a plurality of open objects that are open in the application;
for at least some of the plurality of windows, an act of providing a selectively viewable open object list that allows a user to select one of the plurality of open objects to display in the corresponding window from the selectively viewable list that shows at least some of the plurality of open objects.

15. The computer-implemented method in accordance with claim 14, wherein the selectively viewable open object list is a drop down menu.

16. The computer-implemented method in accordance with claim 14, wherein the act of providing a selectively viewable open object list is performed for each of all of the plurality of windows.

17. The computer-implemented method in accordance with claim 14, wherein the corresponding selectively viewable open object list for each of the at least some of the plurality of windows also allows a user to close the open object displayed in the corresponding window.

18. The computer-implemented method in accordance with claim 14, wherein the corresponding selectively viewable open object list for each of the at least some of the plurality of windows also allows a user to switch a displayed object from one open object of the plurality of open objects to another open object of the plurality of open objects.

19. The computer-implemented method in accordance with claim 14, wherein the corresponding selectively viewable open object list for each of the at least some of the plurality of windows also allows a user to open a new object thereby adding to the plurality of open objects.

20. A physical computer program product comprising one or more physical computer-readable media having thereon one or more computer-executable instructions that, when executed by one or more processors of a computing system, causes the computing system to operate an application that displays an application work area that comprises:
a splitting mechanism for splitting the work area into a plurality of windows, each window capable of displaying a selected open object of a plurality of open objects that are open in the application, wherein the splitting mechanism performs splitting both in the horizontal and vertical directions such that a horizontal split for an upper set of windows need not be aligned with a horizontal split for a lower set of windows, and such that a vertical split for a more left set of windows need not be aligned with a vertical split for a more right set of windows;
wherein each of all of the plurality of windows further comprises:
a corresponding distinct drop down list that allows a user to select one of the plurality of open objects to display in the corresponding window, wherein the drop down list allows any of the open objects to be displayed in the corresponding window regardless of whether that open object is already displayed in another of the plurality of windows.
